(19) United States
(12) Patent Application Publication
(10) Pub. No.: US 2009/0161387 A1
(43) Pub. Date: Jun. 25, 2009

(54) Light Guide Plate and Surface Lighting Device

(76) Inventor: Ching-Hua SU, Hsinchu (TW)

Correspondence Address: HDLS Patent & Trademark Services, P.O. BOX 220746, CHANTILLY, VA, 20153-0746, US

(21) Appl. No.: 12/197,312

(22) Filed: Aug. 25, 2008

(30) Foreign Application Priority Data
Dec. 25, 2007 (TW) 096222108

(51) Int. Cl. F21V 7/04

(52) U.S. Cl. 362/620; 362/619

(57) ABSTRACT

A light guide plate includes a transparent body, a plurality strip-shaped light diffusion structures and a plurality of strip-shaped light-collecting structures. The transparent body has a first light exit surface and a light incident surface adjacent to the first light exit surface. The strip-shaped light diffusion structures convexly extend from the first light exit surface of the transparent body and each of the strip-shaped light diffusion structures has a second light exit surface distant from the first light exit surface. The strip-shaped light-collecting structures correspond to the strip-shaped light diffusion structures, and each of the strip-shaped light-collecting structures convexly extends from the second light exit surface of the corresponding strip-shaped light diffusion structure. A cross-sectional shape of each of the strip-shaped light-collecting structures is approximately symmetrical with respect to a central normal plane of the corresponding second light exit surface. Furthermore, a surface lighting device using the above-mentioned light guide plate is also provided.

### BACKGROUND

1. Technical Field

The present invention generally relates to a light guide plate and a surface lighting device using the same and particularly to a light guide plate with improved light diffusion and light-collecting structures and a surface lighting device using the same.

2. Description of the Related Art

Generally, a display apparatus which needs a backlight source, such as a liquid crystal display needs a surface lighting device (e.g., a backlight module) to provide a backlight source, in order to display an image. The surface lighting device is to provide the backlight source with enough brightness and good uniformity.

A conventional side-edge backlight module using light emitting diodes (LEDs) as the light source thereof includes a plurality of LEDs and a light guide plate. The LEDs are arranged in a linear manner and disposed adjacent to a light incident surface of the light guide plate. The light guide plate is to guide transmission directions of light beams emitted from the LEDs and convert the light beams into a surface light source as output. In order to achieve the purpose of uniform light output from the light guide plate, one conventional approach is to form micro-structures on the light incident surface of the light guide plate. Although the microstructures may diffuse a part of the light beams, a phenomenon of bright and dark stripes is still existed. One approach for suppressing the phenomenon of bright and dark stripes is to configure a surface of the light guide plate which is opposite to the light output surface thereof as a reflective surface and forms V-shaped grooves on the reflective surface (as disclosed in the Taiwanese Utility Model Patent No. M269409). However, since the inherent characteristic of the LEDs, assisted by the reflective surface with the V-shaped grooves of the light guide plate, the phenomenon of bright and dark stripes still occurs at a position adjacent to the light incident surface of the light guide plate and thus the light output uniformity of the backlight module is degraded.

Another Taiwanese Invention Patent No. 1252938 discloses a light guide plate and a backlight module using the light guide plate. The light guide plate includes a light diffusion part bound on a light exit surface of a transparent plate. The light diffusion part includes organic spherical filler particles bound on the light exit surface by a binder. However, the light diffusion part still could not eliminate the phenomenon of bright and dark stripes. In another aspect, the light diffusion part only may diffuse the light beams but could not achieve light-collecting effect.

### BRIEF SUMMARY

The present invention relates to a light guide plate may not be easily scratched and for improving the light output uniformity and brightness.

The present invention further relates to a surface lighting device for providing a surface light source with high light output uniformity and brightness.

Other objectives, features and advantages of the present invention will be further understood from the further technological features disclosed by the embodiments of the present invention

In order to achieve one, part, all of the above-mentioned or other advantages, a light guide plate in accordance with a present embodiment is provided. The light guide plate includes a transparent body, a plurality of strip-shaped light diffusion structures and a plurality of strip-shaped light-collecting structures. The transparent body includes a first light exit surface and a light incident surface adjacent to the first light exit surface. The strip-shaped light diffusion structures convexly extend from the first light exit surface of the transparent body and each has a second light exit surface distant from the first light exit surface. The strip-shaped light-collecting structures correspond to the strip-shaped light diffusion structures, and each of the strip-shaped light-collecting structures convexly extends from the second light exit surface of the corresponding strip-shaped light diffusion structure. A cross-sectional shape of each of the strip-shaped light-collecting structures is approximately symmetrical with respect to a central normal plane of the corresponding second light exit surface. The central normal plane is substantially parallel to a lengthwise direction of the corresponding strip-shaped light diffusion structure.

A surface lighting device in accordance with another present embodiment is provided. The surface lighting device includes a light guide plate and a light source. The light guide plate includes a transparent body, a plurality of strip-shaped light diffusion structures and a plurality of strip-shaped light-collecting structures. The transparent body includes a first light exit surface and a light incident surface adjacent to the first light exit surface. The strip-shaped light diffusion structures convexly extend from the first light exit surface of the transparent body and each has a second light exit surface distant from the first light exit surface. The strip-shaped light-collecting structures correspond to the strip-shaped light diffusion structures, and each of the strip-shaped light-collecting structures convexly extends from the second light exit surface of the corresponding strip-shaped light diffusion structure. A cross-sectional shape of each of the strip-shaped light-collecting structures is approximately symmetrical with respect to a central normal plane of the corresponding second light exit surface. The light source is disposed adjacent to the light incident surface of the transparent body.

Since the first light exit surface of the light guide plate in accordance with the present embodiments has the combined structure, combined of the strip-shaped light diffusion structures and strip-shaped light-collecting structures, formed thereon, both of the effects of light diffusion and light-collecting may be achieved and thereby the light output uniformity and brightness may be improved.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, three-dimensional view of a surface lighting device in accordance with an embodiment of the present invention.

FIG. 2 is a schematic, front view of the light guide plate of FIG. 1.

FIG. 3 is a schematic, front view of a light guide plate in accordance with another embodiment of the present invention.

FIG. 4 is a schematic, front view of a light guide plate in accordance with further another embodiment of the present invention.

FIG. 5 is a schematic, front view of a light guide plate in accordance with still further another embodiment of the present invention.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

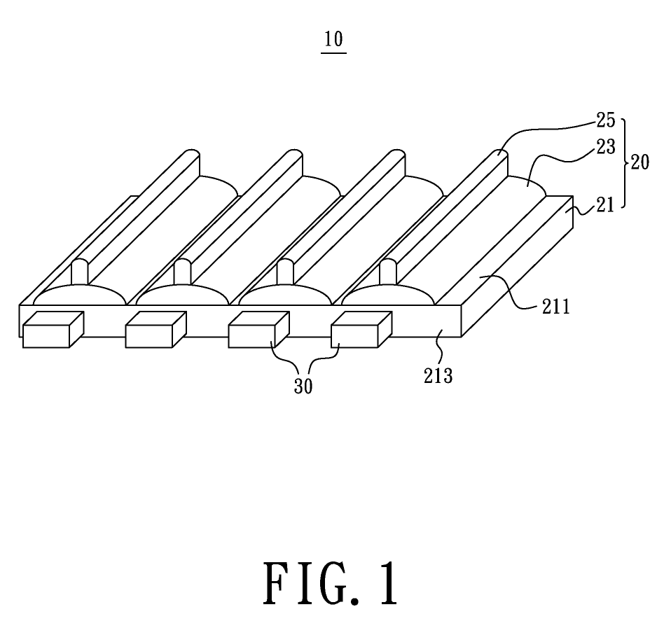

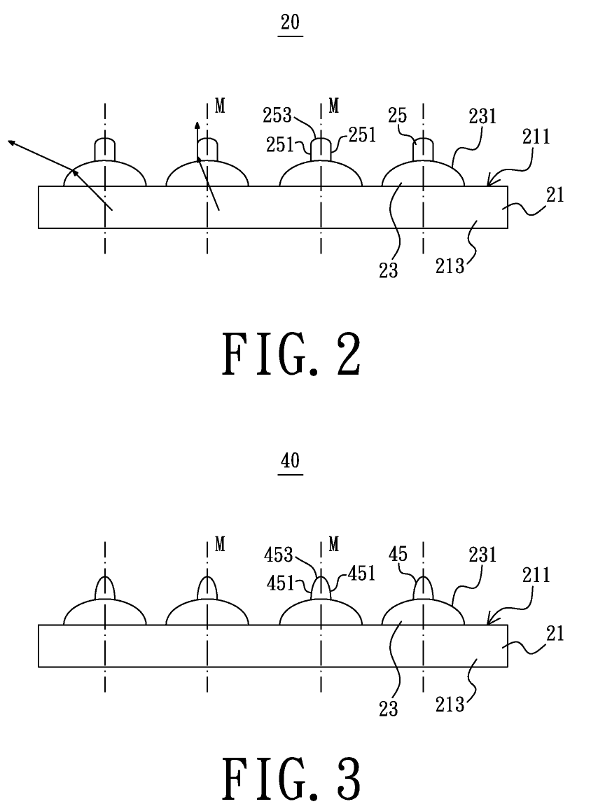

Referring to FIGS. 1 and 2, a surface lighting device 10 in accordance with an embodiment or the present invention is provided. The surface lighting device 10 includes a light guide plate 20 and a light source 30. The light guide plate 20 includes a transparent body 21, a plurality of strip-shaped light diffusion structures 23 and a plurality of strip-shaped light-collecting structures 25.

The transparent body 21 includes a first light exit surface 211 and a light incident surface 213 adjacent to the first light exit surface 211. The transparent body 21 may be plate-shaped (as illustrated in FIG. 1) or wedge-shaped. The transparent body 21 may be made of an optically transparent material, such as poly acrylic acid resin, carbonate, polyethylene resin or poly methyl methacrylate (PMMA).

The strip-shaped light diffusion structures 23 are disposed spaced apart from each other and convexly extend from the first light exit surface 211 of the transparent body 21. Each of the strip-shaped light diffusion structures 23 may be a lenticular lens and has a second light exit surface 231 distant from the first light exit surface 211 of the transparent body 21. The second light exit surface 231 may be a curved surface.

The strip-shaped light-collecting structures 25 correspond to the strip-shaped light diffusion structures 23, and each of the strip-shaped light-collecting structures 25 convexly extend from the second light exit surface 231 of the corresponding strip-shaped light diffusion structure 23. Each of the strip-shaped light-collecting structures 25 is approximately symmetrical with respect to a central normal plane M (as denoted by dashed line of FIG. 2) of the corresponding second light exit surface 231. The central normal plane M is substantially parallel to the lengthwise direction (i.e., generally the extension direction) of the corresponding strip-shaped light diffusion structure 23. In other words, the cross-sectional shape of each of the strip-shaped light-collecting structures 25 is approximately symmetrical with respect to the central normal plane M of the corresponding second light exit surface 231. Each of the strip-shaped light-collecting structures 25 may be a prism structure with curved top surface and includes two opposite flat side surfaces 251 and a top surface 253 connected between the two flat side surfaces 251. In the illustrated embodiment, the two side surfaces 251 are approximately parallel to each other and the top surface 253 is a curved surface. A curvature of the top surface 253 of each of the strip-shaped light-collecting structures 25 is larger than a curvature of the second light exit surface 231 of the corresponding strip-shaped light diffusion structure 23.

The light source 30 is disposed adjacent to the light incident surface 213 of the light guide plate 20 and to provide light beams to the light guide plate 20. As illustrated in FIG. 1, the light source 30 includes a plurality of light emitting diodes arranged in a linear manner to form a linear light source. It is understood that the light source 30 is not limited to the linear light source constituted by the light emitting diodes, and may be other type linear light source such as a cold cathode fluorescent lamp (CCFL). In addition, for a small-sized light guide plate, the light source 30 may be consisted of single light emitting diode or other type point light source.

In the present embodiment, since the light guide plate 20 is configured with a combined structure, combined of the strip-shaped light diffusion structures 23 and the strip-shaped light-collecting structures 25, on the first light exit surface 211 thereof, the strip-shaped light diffusion structures 23 may enlarge the illumination angle of the light guide plate 20 and suppress the phenomenon of light and dark stripes at the position adjacent to the light incident surface 213, therefore the light output uniformity of the surface lighting device 10 may be effectively improved. In another aspect, the strip-shaped light-collecting structures 25 may collect (i.e., generally focus) a part of light beams emitted from the second light exit surfaces 231 of the strip-shaped light diffusion structures 23 to compensate the decreased brightness resulting from the uniformization of the strip-shaped light diffusion structures 23. As a result, both of the effects of light output uniformity and brightness of the surface lighting device 10 may be improved. Furthermore, by disposing the curved top surfaces 253 of the strip-shaped light-collecting structures 25, it is advantageously for the achievement of higher light output uniformity and brightness of the surface lighting device 10.

In addition, the strip-shaped light diffusion structures 23 and strip-shaped light-collecting structures 25 of the light guide plate 20 in the present embodiment are not limited to the above-mentioned structural configurations, and may be other suitable structural configurations including for example the structural configurations as described below.

Referring to FIG. 3, in another embodiment, the first light exit surface 211 of the transparent body 21 of the light guide plate 40 has a plurality of strip-shaped light diffusion structures 23 and a plurality of strip-shaped light-collecting structures 45 formed thereon. Each of the strip-shaped light-collecting structures 45 convexly extend from the second light exit surface 231 of the corresponding strip-shaped light diffusion structure 23. Each of the strip-shaped light-collecting structures 45 is approximately symmetrical with respect to the central normal plane M (as denoted by the dashed line of FIG. 3) of the corresponding strip-shaped light diffusion structure 23. In another words, the cross-sectional shape of each of the strip-shaped light-collecting structures 45 is approximately symmetrical (i.e., mirrored) with respect to the central normal plane M of the corresponding second light exit surface 231. Each of the strip-shaped light-collecting structures 45 is a prism structure with curved top surface and includes two opposite curved side surfaces 451 and a top surface 453 connected between the two curved side surfaces 451. The top surface 453 may be a curved surface.

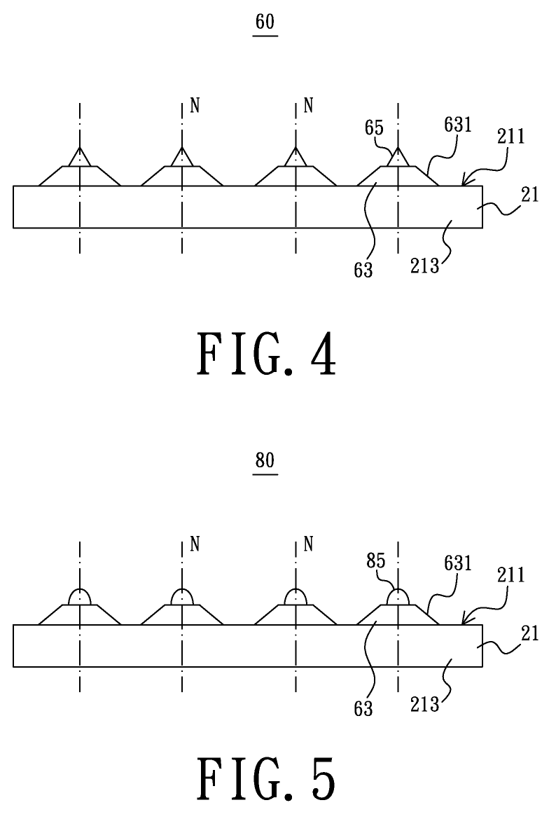

Referring to FIG. 4, in still another embodiment, the first light exit surface 211 of the transparent body 21 of the light guide plate 60 has a plurality of strip-shaped light diffusion structures 63 and a plurality of strip-shaped light-collecting structures 65. In the illustrated embodiment, each of the strip-shaped light diffusion structures 63 is an strip-shaped trapezoidal structure and has a second light exit surface 631 distant from the first light exit surface 211. A cross section of each of the strip-shaped trapezoidal structures is a trapezoid. As shown in FIG. 4, the second light exit surface 631 includes two oblique surfaces and a flat surface connected between the two oblique surfaces. Each of the strip-shaped light-collecting structures 65 convexly extends from the second light exit surface 631 of the corresponding trapezoidal structure and approximately symmetrical with respect to a central normal plane N (as denoted by the dashed line of FIG. 4) of the corresponding second light exit surface 631. The central normal plane N is substantially parallel to the lengthwise direction (i.e., generally the extension direction) of the corresponding one strip-shaped light diffusion structure 63. In other words, the cross-sectional shape of each of the strip-shaped light-collecting structures 65 is approximately symmetrical with respect to the central normal plane N of the corresponding one second light exit surface 631. Each of the strip-shaped light-collecting structures 65 may be a triangular prism structure.

Referring to FIG. 5, in further still another embodiment, the first light exit surface 211 of the transparent body 21 of the light guide plate 80 has a plurality of strip-shaped light diffusion structures 63 and a plurality of strip-shaped light-collecting structures 85 formed thereon. Each of the strip-shaped light-collecting structures 85 convexly extends from the second light exit surface 631 of the corresponding strip-shaped trapezoidal structure and approximately symmetrical with respect to the central normal plane N (as denoted by the dashed line of FIG. 5) of the corresponding second light exit surface 631. In other words, the cross-sectional shape of each of the strip-shaped light-collecting structures 85 is approximately symmetrical with respect to the central normal plane N of the corresponding second light exit surface 631. Each of the strip-shaped light-collecting structures 85 may be a lenticular lens and a top surface thereof has a predetermined radian. It is understood that the light guide plate 80 in the present embodiment can have the strip-shaped light-collecting structures 25 or 45 each of which is a prism structure with curved top surface as illustrated in FIG. 2 or FIG. 3, instead.

Since the first light exit surface of the light guide plate in accordance with the present embodiments has the combined structure, combined of the strip-shaped light diffusion structures and strip-shaped light-collecting structures, formed thereon, both of the effects of light diffusion and light-collecting may be achieved and thereby the light output uniformity and brightness may be improved. In addition, the top surface of each of the strip-shaped light-collecting structures has a predetermined radian and thus may not be easily scratched to degrade the light output quality of the surface lighting device.

The foregoing description of the preferred embodiments of the invention have been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate comprising:
a transparent body having a first light exit surface and a light incident surface adjacent to the first light exit surface;
a plurality of strip-shaped light diffusion structures convexly extending from the first light exit surface of the transparent body, each of the strip-shaped light diffusion structures having a second light exit surface distant from the first light exit surface; and
a plurality of strip-shaped light-collecting structures corresponding to the strip-shaped light diffusion structures, each of the strip-shaped light-collecting structures convexly extending from the second light exit surface of the corresponding strip-shaped light diffusion structure, wherein a cross-sectional shape of each of the strip-shaped light-collecting structures is approximately symmetrical with respect to a central normal plane of the corresponding second light exit surface, and the central normal plane is substantially parallel to a lengthwise direction of the corresponding strip-shaped light diffusion structure.

2. The light guide plate as claimed in claim 1, wherein each of the strip-shaped light diffusion structures is a lenticular lens and each of the second light exit surfaces is a curved surface.

3. The light guide plate as claimed in claim 2, wherein each of the strip-shaped light-collecting structures is a prism structure with curved top surface.

4. The light guide plate as claimed in claim 3, wherein the prism structure with curved top surface comprises two opposite flat side surfaces and a curved top surface connected between the two flat side surfaces.

5. The light guide plate as claimed in claim 4, wherein a curvature of the curved top surface of the prism structure with curved top surface is larger than a curvature of the second light exit surface of the corresponding lenticular lens.

6. The light guide plate as claimed in claim 3, wherein the prism structure with curved top surface comprises two opposite curved side surfaces and a curved top surface connected between the two curved side surfaces.

7. The light guide plate as claimed in claim 1, wherein each of the strip-shaped light diffusion structures is a strip-shaped trapezoidal structure, and each of the second light exit surfaces comprises two oblique surfaces and a flat surface connected between the two oblique surfaces.

8. The light guide plate as claimed in claim 7, wherein each of the strip-shaped light-collecting structures is a triangular prism structure.

9. The light guide plate as claimed in claim 7, wherein each of the strip-shaped light-collecting structures is a lenticular structure.

10. The light guide plate as claimed in claim 7, wherein each of the strip-shaped light-collecting structures is a prism structure with curved top surface.

11. The light guide plate as claimed in claim 10, wherein the prism structure with curved top surface comprises two opposite flat side surfaces and a curved top surface connected between the two flat side surfaces.

12. The light guide plate as claimed in claim 11, wherein a curvature of the curved top surface of the prism structure with curved top surface is larger than a curvature of the second light exit surface of the corresponding strip-shaped light diffusion structure.

13. The light guide plate as claimed in claim 10, wherein the prism structure with curved top surface comprises two opposite curved side surfaces and a curved top surface connected with the two curved side surfaces.

14. A surface lighting device comprising:
a light guide plate comprising:
a transparent body having a first light exit surface and a light incident surface adjacent to the first light exit surface;
a plurality of strip-shaped light diffusion structures convexly extending from the first light exit surface of the transparent body, each of the strip-shaped light diffusion structures having a second light exit surface distant from the first light exit surface; and
a plurality of strip-shaped light-collecting structures corresponding to the strip-shaped light diffusion structures, each of the strip-shaped light-collecting structures convexly extending from the second light exit surface of the corresponding strip-shaped light diffusion structure, wherein a cross-sectional shape of each of the strip-shaped light-collecting structures is approximately symmetrical with respect to a central normal plane of the corresponding second light exit surface, and the central normal plane is substantially parallel to a lengthwise direction of the corresponding strip-shaped light diffusion structure; and
a light source disposed adjacent to the light incident surface of the transparent body.

15. The surface lighting device as claimed in claim 14, wherein each of the strip-shaped light diffusion structures is a lenticular lens and each of the second light exit surfaces is a curved surface.

16. The surface lighting device as claimed in claim 15, wherein each of the strip-shaped light-collecting structures is a prism structure with curved top surface.

17. The surface lighting device as claimed in claim 16, wherein the prism structure with curved top surface comprises two opposite flat side surfaces and a curved top surface connected between the two flat side surfaces.

18. The surface lighting device as claimed in claim 17, wherein a curvature of the curved top surface of the prism structure with curved top surface is larger than a curvature of the second light exit surface of the corresponding lenticular lens.

19. The surface lighting device as claimed in claim 16, wherein the prism structure with curved top surface comprises two opposite curved side surfaces and a curved top surface connected between the two curved side surfaces.

20. The surface lighting device as claimed in claim 14, wherein each of the strip-shaped light diffusion structures is a strip-shaped trapezoidal structure, and each of the second light exit surfaces comprises two oblique surfaces and a flat surface connected between the two oblique surfaces.

21. The surface lighting device as claimed in claim 20, wherein each of the strip-shaped light-collecting structures is a triangular prism structure.

22. The surface lighting device as claimed in claim 20, wherein each of the strip-shaped light-collecting structures is a lenticular lens.
